(19) United States
(12) Patent Application Publication
(10) Pub. No.: US 2007/0125243 A1
(43) Pub. Date: Jun. 7, 2007

(54) Automatic marking system for bakery products

(76) Inventor: Genaro Campa Monroy, Metepec (MX)

Correspondence Address: FISH & RICHARDSON P.C., P.O. BOX 1022, MINNEAPOLIS, MN, 55440-1022, US

(21) Appl. No.: 11/512,704

(22) Filed: Aug. 30, 2006

(30) Foreign Application Priority Data
Aug. 30, 2005 (MX) PA/A/2005/009229

(51) Int. Cl. A23G 1/10

(52) U.S. Cl. 99/485

(57) ABSTRACT

An automated marking system for bakery products may include a support structure disposed over a conveyor. Trays may be positioned on the conveyor. Dough balls that will form the bakery product may be disposed in cavities of the tray. Dough balls may be covered by a dough layer. The support structure includes a marking head with at least one plate attached to the support structure by triggering means that provides a vertical movement. A lower side of a plate may include a template with a plurality of thermal molds for marking dough. An optical sensor may be disposed in the structure to detect the position of each tray on the conveyor and to trigger a stop that stops the tray. The plate may be lowered to mark the dough with the thermal molds.

### FIELD OF INVENTION

The present invention falls within the field of means and equipment used for the management, handling and conditioning of bakery products in the bakery industry. More specifically, refers to an automated system that enables the specific marking in diverse bakery products, prior to baking, in order to give them a determined texture, form and appreciation.

### BACKGROUND OF INVENTION

Up to the time prior to this invention, the marking of bakery products, such as the so called “conchas” and other several products took place manually, using for such purpose a manual mould that marks the dough incorporated in the dough ball prior to baking in order to create the lines characteristic of the “conchas” and other products (concentric spiral, snail, or other required marking); however, such manual operation did not achieve the marking uniformity and, sometimes, it was out of the center of the dough ball generating thus poor quality marks affecting the appearance and presentation of the end product. Likewise, in order to carry out such marking it was necessary to use a significant amount of labor, implying thus high production costs and anti-hygienic management of the bakery product as a result of the contact of man with the product. Jointly with the previously stated, the production rate was relatively low and, therefore, the productivity was poor.

In view of the need to make perfect the operation of bakery products marketing, such as “conchas” and other products and since this are high production industrial processes requiring to decrease the process time, to increase productivity together with an increase of operation and process speeds, it was decided to develop an automated marking system of bakery products, requiring for such purpose, a significant investment of economic and human resources, time and a very important effort to develop the system subject matter of the present description.

### OBJECTIVES OF THE INVENTION

The main objective of the present invention is to have an automated marking system of bakery products available, which allows an accurate, fast and efficient marking.

Another objective of the present invention is to make possible such automated marking system of bakery products which also allows the decreasing of process times, increasing productivity, jointly with an increase of operation speeds.

An additional objective of the invention is to allow such automated marking system of bakery products which is also simple, economic and functional.

Another objective of the present invention is to allow such automated marking system of bakery products which also prevents the damage and contamination of the bakery product.

Even, another objective of the invention is to make available such automated marking system of bakery products which also allows the improvement of product quality in the market and therefore, it is reflected in the sales volumes.

Other objectives and advantages of the invention may be apparent from the study of the following description and accompanying drawings with exclusively illustrative but not restrictive purposes.

### BRIEF DESCRIPTION OF THE INVENTION

In general, the automated marking system of bakery products, in agreement with the present invention, consists of a supporting structure established on a tray conveyor with cavities containing the dough balls that will form the bakery product, previously covered with a dough layer; such supporting structure holds a marked head comprising at least a plate fixed to such supporting structure through triggering means providing it an upward and downward straight movement, comprising at least a plate provided in its lower face with a template with a plurality of marking thermal mould; an optimal sensor is provided in the structure in order to detect the position of each tray with dough balls on the conveyor and as soon as the tray arrives to the required position, such sensor triggers a stop provided in such tray conveyor in order to stop the corresponding tray and as soon as it is static, the head going downwards, marking the dough placed over the plurality of dough balls, which will form the bakery product is triggered, coming up in fraction of seconds and striking such stop allowing the pass of such tray.

The cycle is repeated with each tray traveling in such mould conveyor with cavities containing the dough balls that will form the bakery product.

Such triggering means providing a straight motion both, upwards and downwards, going up and down to such marking head, are selected from the group consisting of pneumatic pistons, hydraulic pistons, electro-mechanic systems, among others.

Such marking moulds of the thermal templates have a concave form which, in the concave surface comprise a raised word with the figure that is to be marked in the dough applied on the dough balls, that is heated through electrical resistances, power fed, from a feeding source in order to make the marking on the dough ball paste of the bakery product to be formed and to prevent that the dough is bonded to the mould embossment. Such electrical resistances have a preferable value of 400 watts.

In its preferred mode, the head comprises two plates holding each of them a former or template provided with twenty thermal marking moulds, being triggered such marking head preferably by two pneumatic pistons.

In order to better understand the characteristics of the invention accompany to the present description, as an integral part thereof, the drawings with exclusively illustrative but not restrictive purposes which are described below.

### BRIEF DESCRIPTION OF THE DRAWINGS

FIG. 1 shows a conventional perspective of the automated marking system of bakery products.

FIG. 2 illustrates a side view of the automated marking system of bakery products.

FIG. 3 shows a superior perspective of a marking former or template.

FIG. 4 illustrates a lower perspective view of a marking concave thermal mould.

In order to better understand the present invention, the detailed description of some of the modes thereof will be discussed below, same which are shown in the drawings which, with exclusively illustrative but not restrictive purposes, are attached to the present description.

### DETAILED DESCRIPTION OF THE INVENTION

The characteristic details of the automated marking system of bakery products are clearly shown in the following description and in the illustrative attached drawings, serving them as a point of reference to indicate the same parts referred to.

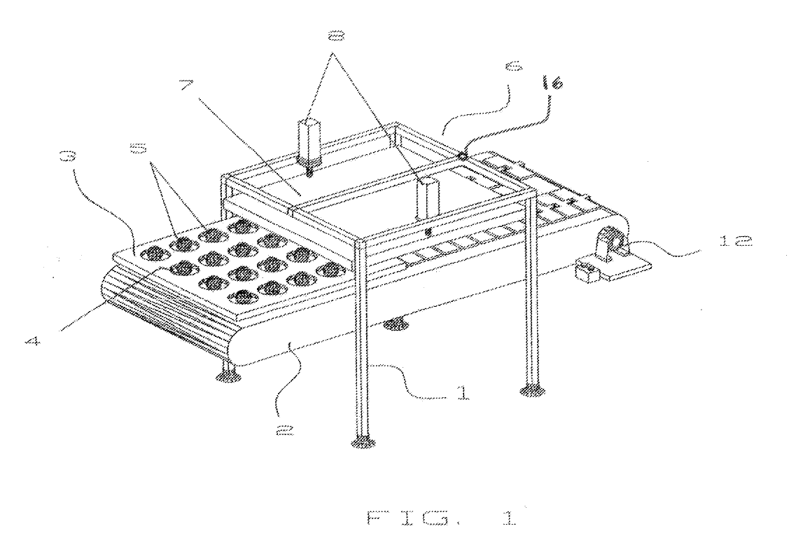

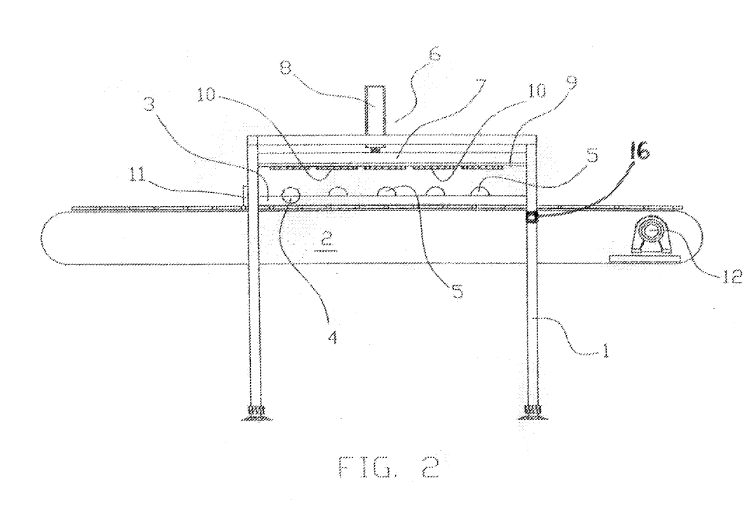

Referring to FIGS. 1 and 2, showing a conventional perspective and a side view, respectively, of the automated marking system of bakery products. In such figure, the system comprises a supporting structure 1 over a conveyor 2 of trays 3 with cavities 4 where dough balls are contained 5 which will form the bakery product, previously covered with a dough layer; such supporting structure 1 sustains at the upper part a marking head 6 consisting of a plate 7 fixed to such supporting structure 1 by means of a pair of pneumatic pistons 8 vertically displaying upward and downward, such plate 7 comprising in its lower side a former or template 9 with a plurality of marking thermal moulds 10; an optimal sensor (not shown) is provided in the supporting structure 1 to detect the position of each tray 3 with dough balls 5 on the conveyor 2, which triggers a stop 11 arranged at the center of such conveyor 2 of trays 3 to stop the corresponding tray 3 and, as soon as it is static, pistons 8 are triggered, same that lower the plate 7 positioning the thermal moulds 10 of the marking former or template 9 on the dough balls 5 marking the dough arranged on a plurality of dough balls 5 that will form the bakery product; lifting immediately such plate 7 because of the effects of such pneumatic pistons 8 and lowering such stop 11 allowing the pass of such tray 5 to the baking.

It can be observed that the conveyor 2 is triggered by an engine 12.

The stop on such conveyor 2 can be triggered with another piston receiving the signal from the optical feeler or sensor.

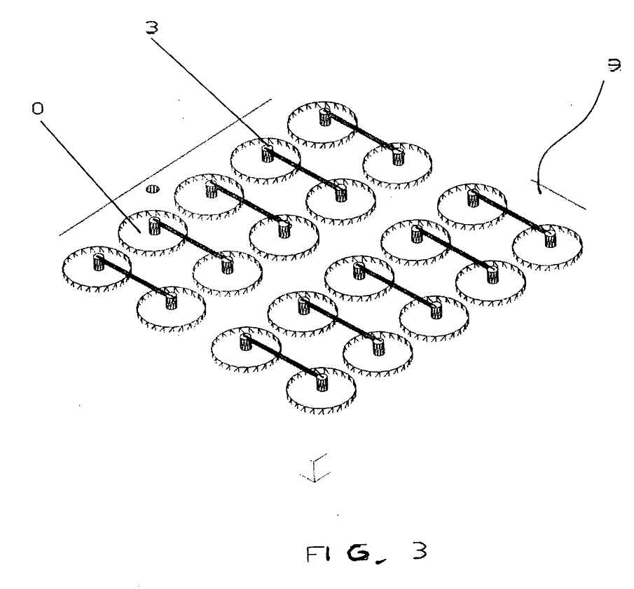

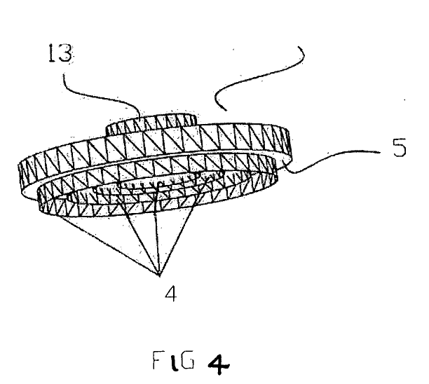

Reference to FIG. 3, that illustrates an upper view of a marking former or template and to FIG. 4 showing a lower view of a thermal mould. In such figures can be observed a former or template 9 with a plurality of thermal marking moulds 10, which comprise electrical resistances 14 power fed from a feeding source (not shown) to heat the embossment 14 with the figure to be marked on the dough applied on the dough balls comprised in the concave surface 15 of such thermal marking moulds 10; such embossment 14 marks the dough on the dough balls of the bakery product to be formed and prevents that the dough bonds to such embossment. Such electrical resistances 13 have a preferable value of 400 watts.

The invention has been sufficiently described so that a person with average knowledge in the matter is able to reproduce and obtain the results mentioned in the present invention. Nevertheless, any skilled person in the technical field related to the present invention might be capable of making modifications that are not described in the present application, which for the application of these modifications in a determined structure or in the same manufacturing process, the matter claimed in the following claims is required, and such structures shall be comprised within the scope of the invention.

1-4. (canceled)

5. An automated marking system for bakery products comprising:
a conveyor;
a support structure disposed above the conveyor, wherein the support structure includes:
a marking head comprising:
at least one plate, wherein a lower side of at least one of the plates includes a template with a plurality of thermal molds for marking dough on a tray on the conveyor disposed below the marking head; and
at least one piston operable to lower the marking head, wherein at least one of the plates is attached to the support structure by at least one of the pistons; and
an optical sensor disposed on the support structure and operable to detect a position of the tray on the conveyor; and
a stop actuated by the optical sensor, wherein the stop is adapted to be raised to stop the tray on the conveyor, and wherein the stop is adapted to be lowered by the marking head striking the stop when the marking head is lowered to contact the dough.

6. The system of claim 5 wherein the piston is pneumatic piston.

7. The system of claim 5 wherein the piston is hydraulic piston.

8. The system of claim 5 wherein the piston is electromechanical piston.

9. The system of claim 5 wherein the thermal molds includes a concave surface, and wherein the concave surface includes a figure to be marked on the dough.

10. The system of claim 5 wherein the thermal molds include electrical resistors to heat the thermal molds.

11. The system of claim 10 wherein the electrical resistors include 400 watt electrical resistors.

12. The system of claim 5 further comprising a tray positioned on the conveyor, wherein the tray includes dough balls covered with a dough layer, wherein the dough balls are positioned in cavities of the tray.

13. The system of claim 12, wherein lowering at least one of the plates marks the dough layer covering the dough balls.

14. An automated marking system for bakery products comprising:
a conveyor;
one or more trays disposed on the conveyor, wherein one or more of the trays comprise cavities, and wherein dough to form bakery products may be disposed in the cavities;
a support structure disposed above the conveyor, wherein the support structure includes:
a marking head comprising:
at least one plate, wherein a lower side of at least one of the plates includes a template with a plurality of thermal molds for marking the dough; and
at least one piston, wherein at least one of the plates is attached to the support structure by at least one of the pistons, and wherein at least one of the pistons is operable to lower at least one of the plates which allows the thermal molds to mark the dough in cavities of at least one of the trays; and
an optical sensor disposed on the support structure and operable to detect a position of one or more of the trays on the conveyor; and
a stop actuated by the optical sensor, wherein the stop is adapted to be raised to stop the tray on the conveyor, and wherein the stop is adapted to be lowered by the marking head striking the stop when the marking head is lowered to contact the dough.

15. The system of claim 14 wherein the piston is pneumatic piston.

16. The system of claim 14 wherein the piston is hydraulic piston.

17. The system of claim 14 wherein the piston is electromechanical piston.

18. The system of claim 14 wherein the thermal molds includes a concave surface, and wherein the concave surface includes a figure to be marked on the dough.

19. The system of claim 14 wherein the thermal molds include electrical resistors to heat the thermal molds.

20. The system of claim 19 wherein the electrical resistors include 400 watt electrical resistors.

21. A method of marking bakery products comprising:
(a) providing one or more trays on a conveyor, wherein the trays include a plurality of cavities, and wherein dough to form bakery products is disposed in the cavities;
(b) detecting a position of one of the trays using an optical sensor;
(c) stopping one of the trays on the conveyor with a stop triggered by the optical sensor;
(d) lowering at least one plate of a marking head to contact the dough, wherein at least one of the plates includes thermal molds to mark the dough;
(e) marking the dough with the thermal molds;
(f) raising the marking head after the thermal molds mark the dough; and
(g) lowering the stop to allow one or more tray to pass the stop by striking the stop with the marking head.

22. The method of claim 21, wherein steps b through g are repeated to mark successive trays of dough to be marked.
